(19) United States
(12) Patent Application Publication
(10) Pub. No.: US 2005/0141705 A1
(43) Pub. Date: Jun. 30, 2005

(54) Verification method of mobile communication system

(75) Inventors: Chia-Chi Kao, Taichung (TW); Ping-Chung Yang, Taoyuan (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/016,057

(22) Filed: Dec. 17, 2004

(30) Foreign Application Priority Data
Dec. 31, 2003 (TW) 92137657

(51) Int. Cl. H04K 1/06

(52) U.S. Cl. 380/37

(57) ABSTRACT

A security verification method of a mobile communication system is provided. The method includes: (1) a first key and a second key are generated and stored in a first processor and a second processor respectively; (2) when receiving a request, the first processor generates a first message and encrypts the first message into a first encrypted message with a first key; (3) the first encrypted message is transmitted to the second processor; (4) the second processor decrypts the first encrypted message and generates a second message with a second key; (5) the second processor encrypts the second message into a second encrypted message with the first key; (6) the second encrypted message is transmitted to the first processor; and (7) the first processor decrypts the second encrypted message to a third message with the second key, and the request is allowed if the third message is verified by the first processor.

### CROSS-REFERENCE TO RELATED APPLICATIONS

This Application claims priority to Taiwan Patent Application No. 092137657 entitled “Verification Method of Mobile Communication System,” filed Dec. 31, 2003.

### FIELD OF INVENTION

A security verification method of a mobile communication system is provided in the present invention. By transmitting and verifying the encrypted messages between the mobile device and the security unit of the system, the method ensures a secured usage of the mobile communication device.

### BACKGROUND OF THE INVENTION

With the development and broad application of mobile communication technology, mobile communication has significantly influenced people's lives. Security issues regarding the mobile communication system and the mobile device are becoming more and more important to modern people.

In some designs that prevent non-authorized users from accessing the mobile communication device, users have to input a password manually to pass the verification to access the mobile device. Some other designs permit or reject an access request based on the comparison of the device identification (device ID) stored both in the mobile device and in the communication host, as proposed in the Japanese Patent with publication number JP 11-018147. But the aforementioned solutions based on the device ID do not involve the security verification method.

In terms of securing the mobile communication network, some methods involve transmitting and receiving messages encrypted or decrypted by a specific key (as shown in U.S. published patent application number U.S. 2003/0112977). Another solution is applying a specific algorithm to encrypt and decrypt messages in the communication protocols (see, for example, U.S. Pat. No. 6,237,093).

In terms of securing the mobile communication device, one design involves permitting access to the device only after an encrypted message is transmitted from the mobile device to and verified by the communication system (as shown in U.S. published patent application number U.S. 2002/0081993). Another security design disposes a remote control to restrict the operating range of the electronic device (as disclosed in U.S. published patent application number U.S. 2003/0095044).

### SUMMARY OF THE INVENTION

The present invention provides a verification method of a mobile communication system to ensure the security of the mobile communication system and the mobile device.

The present invention also provides a mobile communication system that operates in coordination with the foregoing verification method to ensure the security of the mobile communication system and the mobile device.

The mobile communication system in the present invention includes a mobile device and a security unit. The mobile device includes an input device, a first wireless interface and a first processor. The security unit includes a second wireless interface and a second processor.

The method includes: (1) A first key and a second key are generated and stored, respectively, in the first processor and the second processor; (2) when the input device receives a request, the first processor generates a first message and encrypts the first message into a first encrypted message with the first key; (3) the first encrypted message is transmitted to the second processor by the first wireless interface and the second wireless interface; (4) the second processor decrypts the first encrypted message and generates a second message with the second key; (5) the second processor encrypts the second message to a second encrypted message with the first key; (6) the second encrypted message is transmitted to the first processor by the second wireless interface and the first wireless interface; and (7) the first processor decrypts the second encrypted message to a third message with the second key, and the request is allowed only when the third message is verified by the first processor.

### BRIEF DESCRIPTION OF THE DRAWINGS

FIG. 1 shows a schematic diagram of the mobile communication system of the present invention.

FIG. 2 shows a flow chart of another embodiment of the present invention.

FIG. 3 shows a schematic diagram of another embodiment of the present invention.

### DETAILED DESCRIPTION

The present invention provides a verification method of a mobile communication system to ensure the security of the mobile communication system and the mobile device.

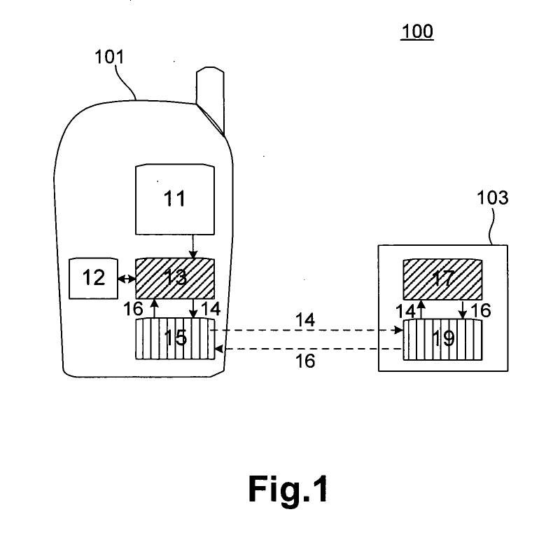

FIG. 1 shows a schematic diagram of the mobile communication system of the present invention. As shown in FIG. 1, the mobile communication system 100 includes a mobile device 101 and a security unit 103. The mobile device 100 includes an input device 11 for users to input instructions, a first wireless interface 15 transmitting and receiving wireless signals, a first processor 13 with encrypting, decrypting and storing functions and a timer 12 connected to the first processor 13. The security unit includes a second wireless interface 19 for transmitting and receiving wireless signals and a second processor 17 with encrypting, decrypting and storing functions.

When the mobile communication system is initialized, the first processor 13 generates a first key and a second key from a random number (or according to other algorithms) and stores them in the first processor 13. The first key and the second key are a couple of encrypting-decrypting keys, with the first key encrypting information and the second key decrypting it. The first key and the second key are transmitted to the second processor 17 by the first wireless interface 15 and the second wireless interface 19. In other embodiments, the second processor 17 can also generate the first key and the second key and transmit them to the first processor 13. It is permitted that the first processor 13 and the second processor 17 generate the same keys respectively.

After the mobile communication system is initialized, the security verification procedure proceeds as the user tries to access the mobile device 101. When the input device 11 receives an access request, the first processor 13 generates a first message and encrypts the first message into a first encrypted message 14 with the first key. The first encrypted message 14 is transmitted to the second processor 17 by the first wireless interface 15 and the second wireless interface 19. Then, the second processor 17 decrypts the first encrypted message 14 with the second key and generates a second message. The second processor 17 can embed device identification (device ID) in the second message to avoid error message transmission. The mobile device 101 stores and confirms the mentioned device ID, as the mobile device 101 receives the messages from the security unit. The second processor 17 encrypts the second message into a second encrypted message 16 with the first key, and then transmits the second encrypted message 16 to the first processor 13 by the second wireless interface 19 and the first wireless interface 15.

The first processor 13 decrypts the second encrypted message 16 into a third message with the second key and verifies the third message. The request is allowed and executed if the third message passes the verification of the first processor 13. The method of verification is to compare the outgoing and incoming message. If the result is the same, the access request is allowed; if the result is not the same, the access request is denied. In addition, the first message generated by the first processor 13 can be a time-varying parameter or a parameter chosen from a plurality of predetermined parameters. The choice from different parameters before transmission makes the verification procedure safer. If the first processor does not receive the second encrypted message 16 transmitted back from the second processor 17 (for examples, due to a weak wireless signal or the mobile device 101 being out of range), the request is rejected. In other words, if the mentioned verification procedure fails, the access request will be denied. Two exceptions are: (1) the request is an emergency call (for example, 112); and (2) the user passes a predetermined password verification to allow the rejected request. The predetermined password verification here includes inputting a password into the mobile device via the input device 11. The mentioned design provides quick access to the mobile device 101 to an authorized user in times of emergency.

As shown in FIG. 1, the mobile device 101 includes a timer 12 connected to the first processor 13, and the timer 12 counts down for a predetermined time interval after the mobile device 101 finishes a task. After the time interval, the verification procedure of the mobile communication system is required. In other words, it helps to reduce power consumption and allows the user to decide whether to activate the verification procedure or not.

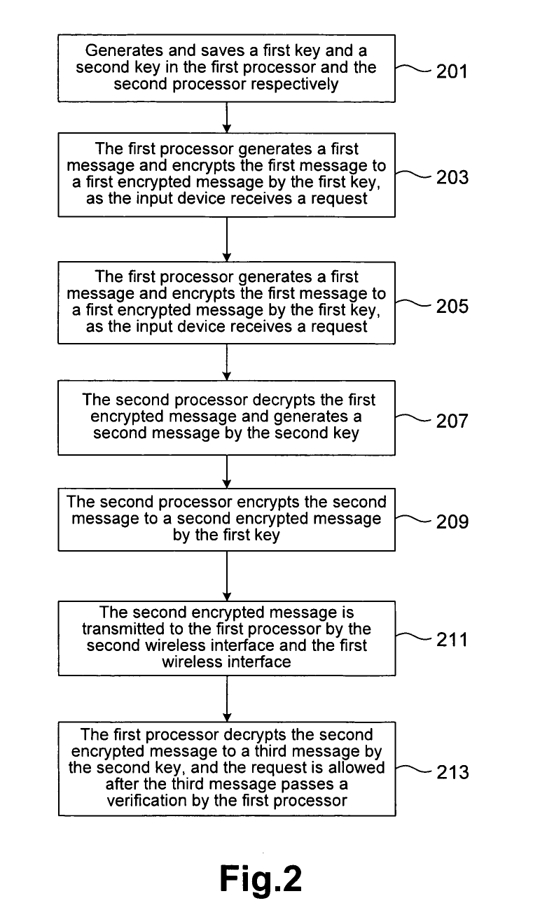

FIG. 2 shows a flow chart of another embodiment of the present invention. The mobile communication system 100 in the present invention takes the following steps; Step 201: a first key and a second key are generated and stored, respectively, in the first processor and the second processor; Step 203: when the input device receives a request, the first processor generates a first message and encrypts the first message into a first encrypted message with the first key; Step 205: as the input device receives a request, the first processor generates a first message and encrypts the first message into a first encrypted message with the first key; Step 207: the second processor decrypts the first encrypted message and generates a second message with the second key; Step 209: the second processor encrypts the second message to a second encrypted message with the first key; Step 211: the second encrypted message is transmitted to the first processor by the second wireless interface and the first wireless interface; Step 213: the first processor decrypts the second encrypted message to a third message with the second key, and the request is allowed after the third message is verified by the first processor. Executing the foregoing steps of the verification of the present invention ensures the security of the communication system. In other embodiments, the verification method also includes: (1) the first key and the second key are generated and stored in the first processor when the mobile communication system is initialized; (2) the second processor receives and stores the first key and the second key transmitted by the first wireless interface and the second wireless interface; (3) the request is rejected when the first processor does not receive the second encrypted message; (4) a password can be inputted into the mobile device to allow the rejected request; (5) the request is rejected when the third message is not verified by the first processor.

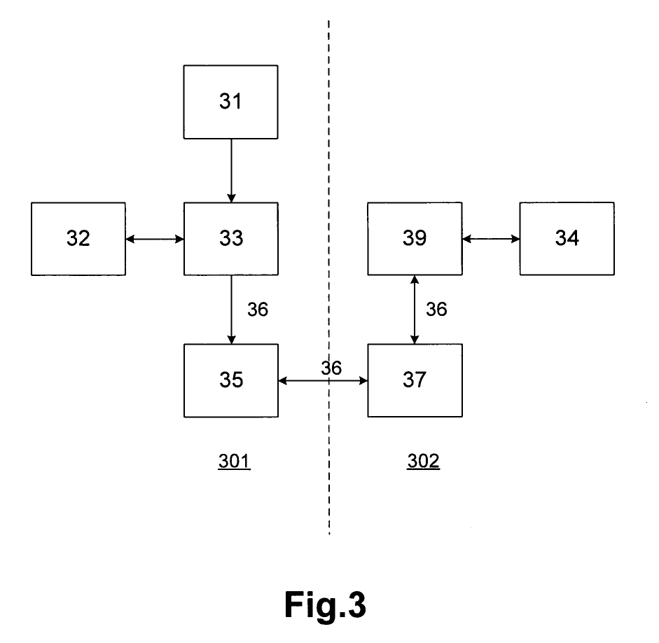

FIG. 3 shows a schematic diagram of another embodiment of the present invention. As shown in FIG. 3, the mobile device 301 includes an input device 31, a first processor 33, a first wireless interface 35 and an encrypting/decrypting unit 32. The security unit 302 includes a second wireless interface 37, a second processor 39 and an encrypting/decrypting unit 34. In this embodiment, when the security verification system is initialized, the input device 31 receives a user's request and the first processor 33 generates an encrypted message 36 with the encrypting/decrypting unit 32. The encrypted message 36 is transmitted to the second processor 39 by the first wireless interface 35 and the second wireless interface 37. The second processor 39 decrypts the encrypted message 36, embeds a device ID in it, and transmits it back to the first processor 33 by the first wireless interface 35 and the second wireless interface 37. The first processor 33 decrypts the encrypted message 36 by the encrypting/decrypting unit 32 and verifies it. If it passes the verification, the user's request will be executed. In yet another embodiment, the mobile communication system also includes a timer (not illustrated) connected to the first processor 33, and the timer counts down for a predetermined time interval. During the time interval, the verification procedure is not activated.

While the invention has been described in connection with what is presently considered to be the most practical and preferred embodiments, it is to be understood that the invention is not to be limited to the disclosed embodiments. The invention is intended to cover various modifications and equivalent arrangements included within the spirit and scope of the appended claims.

1. A security verification method of a mobile communication system, the mobile communication system including a mobile device and a security unit, the mobile device including an input device, a first wireless interface and a first processor, the security unit including a second wireless interface and a second processor, the method comprising:
generating and saving a first key and a second key in the first processor and the second processor respectively;
the first processor generating a first message and encrypting the first message to a first encrypted message by the first key, as the input device receives a request;
the first encrypted message being transmitted to the second processor by the first wireless interface and the second wireless interface;
the second processor decrypting the first encrypted message and generating a second message by the second key;
the second processor encrypting the second message to a second encrypted message by the first key;
the second encrypted message being transmitted to the first processor by the second wireless interface and the first wireless interface; and
the first processor decrypting the second encrypted message to a third message by the second key, and the request is allowed after the third message passing a verification of the first processor.

2. The method according to claim 1, further comprising:
the first processor generating and saving the first key and the second key in the first processor, as the mobile communication system initializes; and
the second processor receiving and saving the first key and the second key transmitted by the first wireless interface and the second wireless interface.

3. The method according to claim 2, wherein the first key and the second key correspond to each other, and information encrypted by the first key is decrypted by the second key.

4. The method according to claim 1, further comprising:
rejecting the request when the first processor doesn't receive the second encrypted message.

5. The method according to claim 4, further comprising:
inputting a password into the mobile device to make the rejected request allowed.

6. The method according to claim 1, further comprising:
rejecting the request when the third message doesn't pass the verification of the first processor.

7. The method according to claim 1, wherein the first message is generated responsive to a time variation.

8. The method according to claim 1, wherein the first message is chosen from a plurality of predetermined messages.

9. The method according to claim 1, wherein a device identification is saved in the mobile device and the security unit, the method further comprising:
embedding the device identification into the second message; and
the device identification being read out from the third message and compared with the device identification saved in the mobile device.

10. The method according to claim 1, wherein the mobile device further includes a timer, the method further comprising:
triggering the timer after finishing the verification of the mobile communication system; and
after the timer counting down to a predetermined time interval, proceed the verification of the mobile communication system.

11. A mobile communication system, comprising:
a mobile device, including:
an input device;
a first processor; and
a first wireless interface; and
a security unit, including:
a second wireless interface; and
a second processor;
wherein, when the mobile communication system initializes, a first key and a second key are generated and saved in the first processor and the second processor respectively, and when the input device receives a request, the first processor generates a first message and encrypts the first message to the first encrypted message by the first key, and the first encrypted message is transmitted to the second processor by the first wireless interface and the second wireless interface, and the second processor decrypts the first encrypted message by the second key and generates a second message, and the second processor encrypts the second message to a second encrypted message by the first key, and the second encrypted message is transmitted to the first processor by the second wireless interface and the first wireless interface, and the first processor decrypts the second encrypted message to a third message by the second key, and the request is allowed after the third message passing a verification of the first processor.

12. The mobile communication system according to claim 11, wherein:
the first processor generates and saves the first key and the second key in the first processor when the mobile communication system initializes; and
the second processor receives and saves the first key and the second key transmitted by the first wireless interface and the second wireless interface.

13. The mobile communication system according to claim 11, wherein the first key and the second key correspond to each other, and information encrypted by the first key is decrypted by the second key.

14. The mobile communication system according to claim 11, wherein the request is rejected when the first processor doesn't receive the second encrypted message.

15. The mobile communication system according to claim 14, wherein a password is input into the mobile device to make the rejected request allowed.

16. The mobile communication system according to claim 11, wherein the request is rejected when the third message doesn't pass the verification of the first processor.

17. The mobile communication system according to claim 11, wherein the first message is generated responsive to a time variation.

18. The mobile communication system according to claim 11, wherein the first message is chosen from a plurality of predetermined messages.

19. The mobile communication system according to claim 11, wherein a device identification is saved in the mobile device and the security unit, and the device identification is embedded into the second message, and the device identification is read out from the third message and compared with the device identification saved in the mobile device.

20. The mobile communication system according to claim 11, wherein the mobile device further includes a timer, and the timer is triggered after finishing the verification of the mobile communication system, and the verification of the mobile communication system is proceeded after the timer counting down to a predetermined time interval.
